(19) United States
(12) Patent Application Publication
(10) Pub. No.: US 2011/0050075 A1
(43) Pub. Date: Mar. 3, 2011

(54) THERMALLY IMPROVED LAMP

(75) Inventor: Josef Kroell, Potsdam (DE)

(73) Assignee: OSRAM GESELLSCHAFT MIT BESCHRAENKTER HAFTUNG, Muenchen (DE)

(21) Appl. No.: 12/866,243

(22) PCT Filed: Feb. 5, 2008
(86) PCT No.: PCT/EP08/51405

§ 371 Date: Aug. 5, 2010

(51) Int. Cl. H01J 5/08; H01J 9/00

(52) U.S. Cl. 313/110; 445/58

(57) ABSTRACT

A lamp having a lamp vessel is provided, the lamp vessel having a shaft, through which a power supply line extends; and a metallically conductive coating on the outer side of the shaft, wherein the maximum layer thickness of the coating is 30 nm, and the layer thickness is designed to minimize the reflection of infrared radiation generated in the lamp.

### TECHNICAL FIELD

This invention relates to an electric lamp, for example a high-pressure gas discharge lamp or a halogen incandescent lamp.

### PRIOR ART

An important criterion in the design of a lamp, for example a halogen lamp or a high-pressure gas discharge lamp, is the heat balance. The thermal radiation generated in the lamp is particularly important.

Common designs of the lamp vessel, which is preferably produced from quartz glass, have one to two shafts through which the power supply lines are routed. Molybdenum film is preferably used in the power supply lines for reasons of sealing, and this film ages increasingly quickly owing to oxidation above a critical temperature. Lamp parts, in particular shafts or power supply lines, can also exhibit temperature-dependent degradation phenomena if other materials are used.

In the case of a lamp as proposed in U.S. Pat. No. 6,084,352, a coating which readily conducts heat and also has a high thermal emissivity is employed on the outer side of the shaft in order to reduce the temperature.

### SUMMARY OF THE INVENTION

This invention is based on the problem of increasing the service life of lamps having shafts.

The invention solves this problem by way of a lamp vessel, said lamp vessel having a shaft, through which a power supply line extends, and a metallically conductive coating on the outer side of the shaft, characterized in that the maximum layer thickness of the coating is 30 nm, and the layer thickness is designed to minimize the reflection of infrared radiation generated in the lamp.

The invention is also directed to the use of the lamp for projection or for film/photographic/stage lighting.

Furthermore, the invention is directed to a process for producing said lamp.

Preferred refinements of the various aspects of the invention are given in the dependent claims and are also apparent from the description which follows. Here, no distinction is made specifically between process, use and device features of the invention, and so the disclosure which follows is to be understood as relating to all of these categories.

The invention is based on the principle of reducing the temperature of the lamp vessel of the lamp, particularly of the shaft, particularly preferably of the shaft end, in order to increase the service life of the lamp, particularly of the power supply lines.

A decisive proportion of the heat that arises when operating a lamp is radiant heat in the form of infrared radiation. In order to discharge the infrared radiation from the lamp vessel, the highest possible degree of transmission is desirable, according to the invention, at the glass-air transition on the outer side of the lamp vessel. In this case, the degree of transmission is governed, inter alia, by the refractive index of the glass and by the angle between the direction in which the infrared radiation propagates and the surface of the lamp vessel. Generally speaking, the smaller this angle is, the lower the transmission; total reflection occurs if there is a sufficiently small angle, and the radiant heat therefore does not leave the lamp vessel.

Owing to the geometry of the lamp vessels, this situation arises particularly in the shaft, which then acts like a waveguide and confines the infrared radiation and leads, in particular, to temperature-sensitive parts, for example the power supply lines.

In order to reduce the heating of the shaft end, according to the invention the transmission of the infrared radiation is to be increased for a wide spectral range on the shaft walls. According to the invention, this is carried out by virtue of the electrically conductive coating on the outer side of the shaft, where the layer thickness should be selected, inter alia, on the basis of the refractive index of the glass of the lamp vessel and the material of the coating.

The functional principle of this coating is described, for example, in WO 2006/086806 A1 and resembles the impedance matching of two waveguides by means of a resistor. During the impedance matching, a resistor is inserted between two waveguides in order to prevent reflection at the transition of these two waveguides. In this model image, the lamp vessel and the space surrounding the vessel represent the waveguides to be matched, and the coating according to the invention corresponds to the impedance-matching resistor. The sheet impedance value of the coating according to the invention is selected such that, for the infrared radiation, the parallel circuit of the sheet impedance with the characteristic impedance of air corresponds to the characteristic impedance of the quartz glass of the lamp vessel. In the invention, the optimum layer thickness consequently correlates to the layer conductivity of the material selected for the coating.

In particular, the coating according to the invention does not correspond to a dichroic coating; instead, the layer thickness in this invention is to be selected to be considerably less than a quarter of the wavelength of the infrared radiation. Unlike dichroic layers, the coating makes a high degree of transmission possible, irrespective of the angle of incidence of the infrared radiation, for the entire infrared spectral range.

Since small angles arise in the shaft between the direction in which the infrared radiation propagates and the surface of the lamp vessel, the coating according to the invention is particularly efficient here. In the region of the lamp vessel provided for the emergence of light, the infrared radiation impinges on the surface of the lamp vessel virtually perpendicularly. Less reflection occurs in this region, and therefore the coating can contribute to a lesser degree to the discharge of the infrared radiation and, owing to its inherent absorption, can more easily have a disruptive effect.

The layer thickness is preferably greater than 2 nm, more preferably 3 nm and particularly preferably at least 4 nm.

The material that is customary and preferred for sealing the power supply lines is molybdenum film, but this oxidizes increasingly at the contact surface with the air as the temperature rises, and therefore the sealing action of said film is reduced and the service life of the lamp is limited. The invention is particularly advantageous in this respect. In addition, however, molybdenum wires leading outward from the molybdenum film, or other metal parts, can also be sensitive to oxidation. If the lamp has two shafts with power supply lines, it is preferable to coat both shafts.

The material used for the coating can be, in particular, the metals aluminum, platinum, iridium, tungsten, nickel, titanium, preferably chromium and alloys, mixtures and multiple layers thereof. According to the invention, the electrical conductivity of the material is needed so that ITO (indium tin oxide) or electrically conductive nanoparticles are also conceivable as the coating, for example, in addition to the conventional metals listed above. The electrically conductive materials chosen are expediently substances which can be applied as a uniform and homogeneous layer with good adhesion and have a sufficient long-term and thermal stability.

The invention can particularly advantageously be applied in the case of halogen lamps and particularly preferably high-pressure gas discharge lamps, preferably those with particularly high power levels. The reduction in temperature of the lamp shaft, which is achieved with the coating according to the invention, serves not only to increase the service life of the lamp, but also makes it possible to reduce the size of the lamp. The optimization of the power/size ratio made possible by the invention is particularly important, for example, for projection lamps. Furthermore, the invention is also advantageous for film lighting, photographic lighting and stage lighting. High lamp powers are desirable for these applications.

Finally, the invention relates to the production of a lamp having the coating according to the invention. Technical processes that are customary for applying coatings are spraying, sputtering, vapor deposition or an immersion bath, these processes including those where a previously applied layer is thinned to the desired layer thickness. One preferred process is ICPECVD (inductively coupled plasma enhanced chemical vapor deposition). This process makes it possible to deposit a metal, which was previously supplied as a metal hydride gas, by means of a plasma in a controlled process that makes it possible to precisely control the layer thickness arising on the lamp vessels, in particular by the application of a plurality of layers each with a self-limited thickness.

### BRIEF DESCRIPTION OF THE DRAWINGS

In the text which follows, the invention will be explained in more detail on the basis of exemplary embodiments, where the features disclosed therein may also be essential to the invention in other combinations and, furthermore, no distinction is made between process, use and device aspects of the invention.

In detail:

FIG. 1 shows a schematic illustration of a high-pressure gas discharge lamp according to the invention,

FIG. 2 shows a comparative lamp from the prior art,

FIG. 3 shows a schematic illustration of the ICPECVD process, and

FIG. 4 shows sheet impedances of thin chromium layers.

### PREFERRED EMBODIMENT OF THE INVENTION

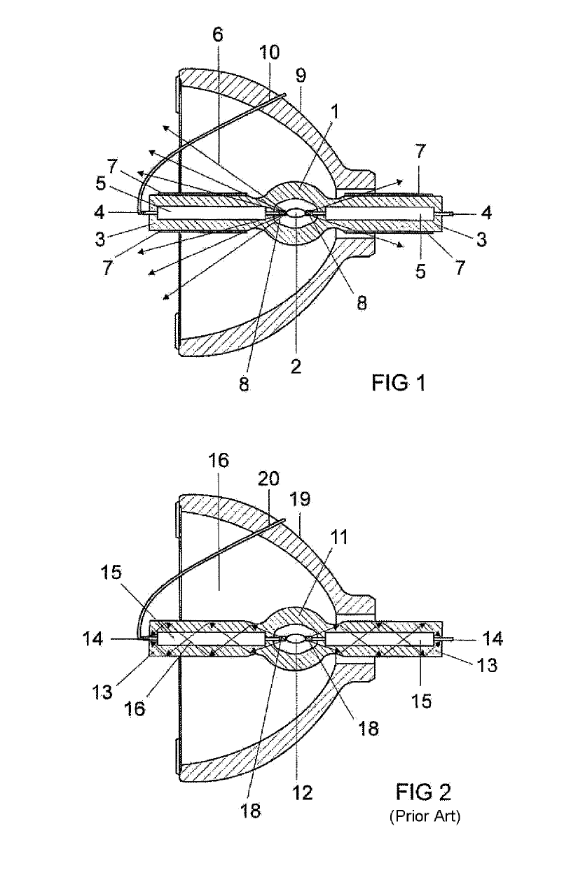

FIG. 1 shows a schematic illustration of a high-pressure gas discharge lamp according to the invention having a reflector 9. For comparison, FIG. 2 shows a lamp having a reflector 19 from the prior art. The lamp vessels 1, 11 of the two lamps are produced from quartz glass and each have two shafts 3, 13 on opposite sides. The power supply lines 4, 14 are routed through the ends of the shafts 3, 13, and the power supply lines 4, 14 within the reflectors 9, 19 are routed with extensions 10, 20 onto the outer side of the reflectors 9, 19. The lamp housings 1, 11 are sealed on molybdenum films 5, 15 in the power supply lines 4, 14 within the shafts 3, 13.

In this type of lamp, an arc 2, 12 between the electrodes 8, 18 represents the light source. This arc 2, 12 is likewise the source of the infrared radiation 6, 16, which is denoted symbolically by arrows.

Supplementarily to the lamp in FIG. 2, FIG. 1 shows the coating 7 according to the invention on the outer side of the shafts 3 of the lamp. The coating consists of chromium, which has a high melting point and forms a protective oxide layer.

The layer thickness of the coating 7 is selected such that, owing to the sheet impedance thereof, impedance matching is effected between the quartz glass of the lamp vessel 1 with a refractive index of about 1.5 and the air which surrounds the lamp vessel 1 and has a refractive index of about 1. Using the ratio of the refractive indices of air and quartz glass, a characteristic impedance of about 251Ω (377Ω/1.5) is obtained in the quartz glass from the characteristic impedance for infrared radiation 6 in air of about 377Ω. On the basis of a parallel circuit of the sheet impedance of the coating 7 and the characteristic impedance in air according to the formula

$$\frac{1}{{Z}_{Quartz}} = \frac{1}{{R}_{Cr}} + \frac{1}{{Z}_{Air}}$$

the ratio of the characteristic impedances

$$\frac{{Z}_{Quartz}}{{Z}_{Air}} = \frac{{n}_{Air}}{{n}_{Quartz}}$$

is used to produce the required sheet impedance of the chromium coating 7 at the optical transition from the quartz glass of the lamp vessel 1 into the air surrounding the lamp vessel 1:

$$\begin{matrix}{R}_{Cr} = \frac{{Z}_{Air} \cdot {Z}_{Quartz}}{{Z}_{Air} - {Z}_{Quartz}} \\ = \frac{{Z}_{Air} \cdot \frac{{Z}_{Air}}{{n}_{Quartz}}}{{Z}_{Air} - \frac{{Z}_{Air}}{{n}_{Quartz}}} \\ = \frac{{Z}_{Air}}{( {n}_{Quartz} - 1 )} \\ ≅ \frac{377 Ω}{1.5 - 1} \\ = 754 Ω\end{matrix}$$

It can be seen from FIG. 4, which shows the sheet impedance of thin chromium layers as a function of their thickness, that a layer thickness of about 5.5 nm is needed for a sheet impedance of about 750Ω. Since it is assumed that a certain degree of oxidation will occur owing to the high temperature of the lamp vessel 1 during operation of the lamp, a coating 7 having a layer thickness of 7 nm is applied in the exemplary embodiment.

This coating 7 causes the profile of the infrared radiation 6 in FIG. 1, which differs, in principle, from the profile of the infrared radiation 16 in FIG. 2. The infrared radiation 6, 16 emanating from the arcs 2, 12 passes into the vessel shafts 3, 13 at small angles with respect to the surface of the vessel shafts 3, 13. In the case of the lamp from the prior art, shown in FIG. 2, total reflection of the infrared radiation 16 takes place on the outer side of the shaft 13 at these small angles. The infrared radiation 16 cannot leave the shaft 13 and is reflected back into the latter, until the infrared radiation 16 impinges on the power supply line 14 at the end of the shaft 13, the constituent parts of said power supply line including the molybdenum film 15. In this case, the shaft 13 acts like a waveguide for the infrared radiation 16, and the infrared radiation 16 guided to the end of the shaft 13 heats the power supply line 14 and the molybdenum film 15. The heating in the region of the shaft 13, in particular of the power supply line 14 and of the molybdenum film 15, results in accelerated oxidation of molybdenum and thus in a reduced service life of the lamp at temperatures above about 350° C. In this case, the effect of the molybdenum film 15, in particular, for sealing the lamp vessel 11 is reduced.

The lamp according to the invention, shown in FIG. 1, has a significantly different profile of the infrared radiation 6. This difference is brought about by a coating 7 according to the invention containing chromium. Just like in the case of the conventional lamp shown in FIG. 2, the infrared radiation 6 of the lamp according to the invention, shown in FIG. 1, penetrates into the shaft 3 of the latter and impinges on the surface of the shaft 3 at the same small angles. However, the coating 7 on the outer side of the shaft 3 means that a greater proportion of the infrared radiation 6 leaves the shaft 3 of the lamp according to the invention, since the coating 7 significantly increases the degree of transmission at the contact surface of the shaft 3 with the space which surrounds the lamp. In particular, the total reflection of the infrared radiation 6 on the outer side of the shaft 3 is prevented, and the shaft 3 no longer acts like a waveguide. In the case of the lamp according to the invention, shown in FIG. 1, significantly less infrared radiation 6 thus passes to the end of the shaft 3, and the power supply line 4 and the molybdenum film 5 thereof are therefore heated to a significantly lower extent. The heat-related wear to the lamp can thus be reduced considerably, and it may be possible for the shaft 3 of the lamp vessel 1 to have a shorter design.

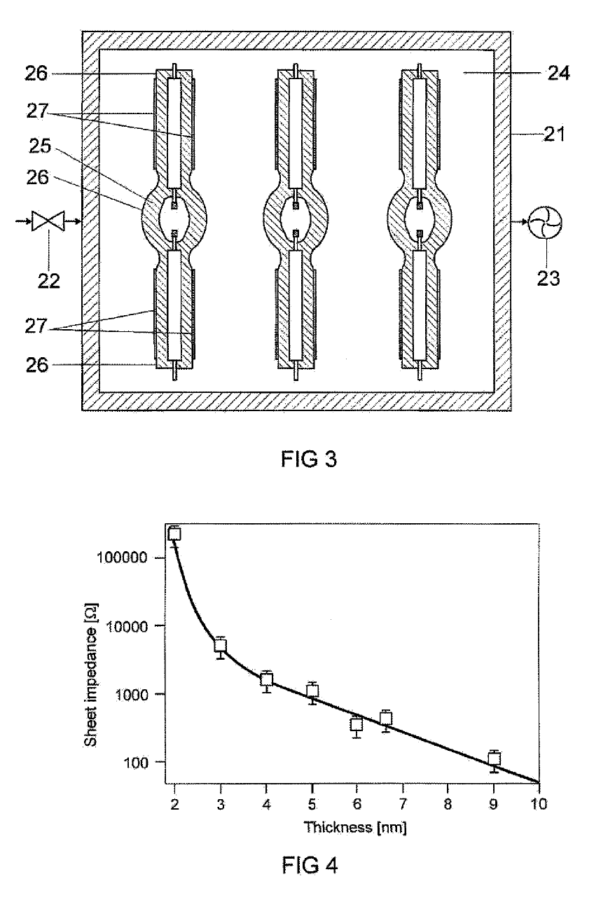

FIG. 3 shows the schematic structure for coating the lamp vessels with a metal, in this example with chromium, using the ICPECVD process. In this process, the deposition chamber 21 is evacuated by means of a vacuum pump 23 and flooded with chromium metal hydride gas via the metal hydride feed 22, with the aim of depositing this metal as a coating 27 on the lamp vessel 25 by means of an argon plasma 24. Here, those regions of the lamp vessel 25 which are not to be coated in this process are covered with a soluble protective coating 26.

This process is distinguished by the fact that it is possible to obtain a uniform, area-covering coating and the layer thickness can be controlled precisely. The deposition of the metal, in this case chromium, on the lamp vessel 26 of quartz glass can be controlled in such a manner that the deposition process stops automatically after a certain number of atomic layers. Local differences, such as the density of the plasma or the reactivity of the metal hydride gas, are compensated for and a high degree of homogeneity of the coating 27 is achieved. This process can be repeated as often as desired, and therefore additional layers of the same metal or of a different metal can be applied.

Furthermore, if the deposition chamber 21 has an appropriate size, a plurality of lamp vessels 25 can be coated at the same time in one operation owing to the high degree of homogeneity when coating using this process. This is a prerequisite when there are relatively large quantities in the production process.

1. A lamp having a lamp vessel, the lamp vessel comprising:
a shaft, through which a power supply line extends; and
a metallically conductive coating on the outer side of the shaft,
wherein the maximum layer thickness of the coating is 30 nm, and the layer thickness is designed to minimize the reflection of infrared radiation generated in the lamp.

2. The lamp as claimed in claim 1,
wherein the coating is applied only in the region of the shaft.

3. The lamp as claimed in claim 1,
wherein the layer thickness is at least 2 nm.

4. The lamp as claimed in claim 1,
wherein the power supply line in the shaft has a molybdenum film.

5. The lamp as claimed in claim 1,
wherein the material of the coating is selected from the group consisting of: chromium; platinum; iridium; tungsten; nickel; titanium; and alloys, mixtures and multiple layers thereof.

6. The lamp as claimed in claim 1, further comprising:
two vessel shafts on sides that are each opposite the location of light generation.

7. The lamp as claimed in claim 1, said lamp being a high-pressure gas discharge lamp.

8. A use of a lamp for projection, the lamp comprising:
a lamp vessel, the lamp vessel comprising:
a shaft, through which a power supply line extends; and
a metallically conductive coating on the outer side of the shaft,
wherein the maximum layer thickness of the coating is 30 nm, and the layer thickness is designed to minimize the reflection of infrared radiation generated in the lamp.

9. A use of a lamp, the lamp comprising:
a lamp vessel, the lamp vessel comprising:
a shaft, through which a power supply line extends; and
a metallically conductive coating on the outer side of the shaft,
wherein the maximum layer thickness of the coating is 30 nm, and the layer thickness is designed to minimize the reflection of infrared radiation generated in the lamp, for at least one selected from a group consisting of: film lighting; photographic lighting; and stage lighting.

10. A process for manufacturing a lamp, the lamp comprising:
a lamp vessel, the lamp vessel comprising:
a shaft, through which a power supply line extends; and
a metallically conductive coating on the outer side of the shaft,
wherein the maximum layer thickness of the coating is 30 nm, and the layer thickness is designed to minimize the reflection of infrared radiation generated in the lamp,
the method comprising
applying an electrically conductive coating to the outer side of a shaft of the lamp, through which shaft a power supply line extends, in such a way as to obtain a maximum layer thickness of 30 nm; and
designing the layer thickness to minimize the reflection of infrared radiation generated in the lamp.

11. The process as claimed in claim 10,
wherein the coating takes place by inductively coupled plasma enhanced chemical vapor deposition.
